(19) United States
(12) Patent Application Publication
(10) Pub. No.: US 2023/0222329 A1
(43) Pub. Date: Jul. 13, 2023

(54) Method and Device Used for Providing and Evaulating a Sensor Model for Change Point Detection

(71) Applicant: Robert Bosch GmbH, Stuttgart (DE)

(72) Inventors: Konrad Groh, Stuttgart (DE); Christian Fleck, Gerlingen (DE); Matthias Woehrle, Bietigheim-Bissingen (DE)

(21) Appl. No.: 18/153,655

(22) Filed: Jan. 12, 2023

(30) Foreign Application Priority Data
Jan. 13, 2022 (DE) 10 2022 200 284.9

(51) Int. Cl. G06N 3/049; G06N 3/084

(52) U.S. Cl. CPC G06N 3/049; G06N 3/084

(57) ABSTRACT

A method evaluates a data-based sensor model for determining a change-point time in a sensor signal time series. The method includes providing an evaluation signal time series within an evaluation time window of a sensor signal time series, and determining sensor signal extracts from the evaluation signal time series. The sensor signal extracts are (i) time-shifted with respect to one another, or (ii) respectively offset from one another by a number of sensing steps. The sensor signal extracts are shorter in length than the evaluation signal time series. The method further includes determining one or more frequency contributions from the sensor signal extracts using a fast Fourier transform (“FFT”) or a Goertzel algorithm, and evaluating the one or more frequency contributions in a trained data-based sensor model in order to determine a change-point time within the evaluation time window.

This application claims priority under 35 U.S.C. § 119 to patent application no. DE 10 2022 200 284.9, filed on Jan. 13, 2022 in Germany, the disclosure of which is incorporated herein by reference in its entirety.

The disclosure relates to a method used for providing and evaluating a sensor model for detecting a change point time in a sensor signal time series, and in particular to measures used for providing a data-based sensor model for evaluating explainable, physically motivated characteristics.

### BACKGROUND

Sensors used for detecting physical variables are often continuously sampled. For example, a pressure, mass flow, acceleration, temperature, vibration, acceleration, or the like can be detected using a suitable sensor. A sensor signal time series in the form of, e.g., an electrical or digitized signal is generally available at predetermined sampling times at the sensor output or the sensor system. Said series indicates a temporal progression of a sensor signal in the form of a sensor signal time series.

For evaluation, such a sensor signal time series can be analyzed so that special characteristics of a technical system can be detected based on the progression of the sensor signal. While the sensor signals can be evaluated in a variety of ways, one application is determining a time of a significant change in a system state (also referred to as a change point time) by evaluating the sensor signal time series. To this end, a sensor model is typically provided that associates information indicative of a change point time by means of an extract from the sensor signal time series.

### SUMMARY

According to the disclosure, there is provided a method for evaluating a data-based sensor model for change-point detection, a method for training a data-based sensor model to provide a change point time based on a predetermined sensor signal time series, as well as corresponding devices.

A first aspect relates to a method used for evaluating a data-based sensor model for determining a change point time in a sensor signal time series, said method comprising the following steps:
providing an evaluation signal time series within an evaluation time window of a sensor signal time series;
determining sensor signal extracts from the evaluation signal time series which are time-shifted with respect to one another or are in each case offset from one another by a number of sensing steps, wherein the sensor signal extracts are shorter in length than the evaluation signal time series;
determining one or more frequency contributions from the sensor signal extracts, in particular using a Fast Fourier Transformation (FFT), Discrete Fourier Transformation (DFT), or Goertzel algorithm; and
evaluating the frequency contributions in a trained data-based sensor model in order to determine a change point time within the evaluation time window.

As described earlier, the above method relates to a sensor model for evaluating a sensor signal time series from a conventional sensor that is continuously being sampled in sensing steps. Such a sensor can be, e.g., a pressure sensor, a mass flow sensor, an accelerometer, a vibration sensor, a radiation sensor, or the like. Sensors of this kind are usually sampled over time at a predetermined sampling frequency in order to monitor a temporal change, thus providing a sensor signal time series in an analog or digitized manner. A sensor signal time series of this kind can be evaluated in a variety of ways.

When monitoring system states, it is often necessary to detect a point in time when a significant state change in the technical system being measured occurs. Such a point in time is called a change point time.

A group of data-based sensor models have proven particularly suitable for evaluating a sensor signal time series in order to determine a change point time. To this end, the sensor signal time series is sampled, and a time period for the sensor signal is selected via an evaluation time window. The period for the sensor signal time series detected within the evaluation time window is fed to the sensor model as the evaluation signal time series in the form of an input vector. Said model can be configured as a data-based classification model so that, depending on the input vector, an output vector is output that is configured as a classification vector. This classification vector typically features dimensionality, with a number of elements each being associated with a class and each being associated with a given point in time within the evaluation window of the sensor signal time series. The argmax of the classification vector corresponds to the classification to be determined, i.e., the index value of the relevant element in the output vector corresponds to a certain predetermined time within the evaluation window. The sensor model can thus be designed to indicate the change point time as a classification vector, wherein the change point time is indicated as argmax of the classification vector.

By using the sensor model as a classification model, an evaluation signal time series is classified and, according to a trained sensor model, a change point time in the sensor signal time series is thereby determined within the selected evaluation signal window. The value for the classification vector element, i.e., typically the element having the highest value, then has an index value that determines the time in the sensor signal time series corresponding to the change point time.

Training such a data-based sensor model is typically performed using predetermined training datasets in an inherently known manner. The training datasets assign a classification vector in the form of a label to an input vector (an evaluation signal time series) that is obtainable by sampling a sensor signal within a predetermined evaluation signal time window.

One problem with data-based sensor models based solely on neural networks is that the behavior of the sensor model is difficult to predict, and an output from the sensor model cannot be guaranteed within a certain range of values. As a result, use in safety-sensitive systems, e.g., systems with driving relevance to motor vehicles and the like, is generally not permitted.

The sensor model can be trained to associate a change point time with the frequency contributions from an evaluation point time series. The frequency contributions can refer to one or more predetermined frequencies.

The above method provides preprocessing of the evaluation signal time series in order to determine physically explicable frequency characteristics.

If the data-based sensor model is evaluated using the frequency-based frequency characteristics, then the behavior is explicable, and the sensor model can thus be applied to safety-sensitive systems.

The sensor model is explicable because the specific frequency characteristics are physically motivated, i.e., such a frequency characteristic is indicative, or is detected, when the frequency is dominant at that point. These characteristics are then aggregated using a linear function, and the Argmax is output as a detected class. In other words, the classification is based on the linear combination of physical features. It can be determined which characteristics are used as a basis for each prediction (and how they are weighted).

According to the above method, an evaluation signal time series from a sensor signal time series is analyzed in a frequency-based manner in order to obtain frequency contributions on a periodic basis for one or more predetermined frequencies. For this purpose, the evaluation signal time series is broken down into several sample time windows that are offset from one another and determined based on the relevant signal time series extracts from the respective one or more respective frequency contributions. It can be provided that the frequency contributions be determined based on one or more predetermined frequencies, in particular a phase state of an underlying sine or cosine signal. For example, the frequency contributions can have amplitude values within a frequency spectrum at predetermined frequencies, e.g., obtained by an FFT or Goertzel algorithm. For example, the frequency signal according to which the signal time-series excerpt is analyzed can correspond to a cosine signal having a predetermined phase and frequency. These values represent hyperparameters of the sensor model.

One or more frequency contributions result in each case from the individual signal time series extracts, which contributions in each case represent an input characteristic with respect to the evaluation signal time series. These extracts compress the information during the progression of the sensor signal time series to a comprehensible frequency contribution. The frequency contributions are then further processed using one or more neuron layers of the sensor model. A regression value or classification vector can be output. The regression value can directly indicate the change point time, and the classification vector can indicate the change point time via the index value as an argmax.

To train such a data-based sensor model, training data time series corresponding to frequency contributions are accordingly extracted as characteristics and associated with a corresponding label, i.e., a change point time. In this case, the sensor model is trained only by adjusting the model parameters of the neuron layer. The training can be performed in an inherently known manner using a gradient-based method.

Another aspect relates to providing a method used for training a data-based sensor model for evaluating an evaluation point time series in order to determine a change point time, said method comprising the following steps:
providing training datasets which are in each case indicative of an evaluation point time series and a label in the form of a change point time;
determining sensor signal extracts from the evaluation signal time series which are time-shifted with respect to one another or are in each case offset from one another by a number of sensing steps, wherein the sensor signal excerpts are shorter in length than the evaluation signal time series;
determining one or more frequency contributions from the sensor signal extracts using an FFT, DFT, or Goertzel algorithm; and
training the data-based sensor model using the frequency contributions and the change point times associated therewith.

A further aspect relates to providing a device used for performing one of the above methods.

### BRIEF DESCRIPTION OF THE DRAWINGS

Embodiments are explained in more detail in the following with reference to the accompanying drawings. Here:

FIG. 1 shows a schematic illustration of a sensor system for detecting sensor signal time series;

FIG. 2 shows a flow chart illustrating a method used for evaluating a data-based sensor model with previous frequency-based characteristic extraction;

FIG. 3 shows a representation of an evaluation signal time series with sensor signal extracts;

FIG. 4 shows a flow chart illustrating a method used for training a data-based sensor model with previous frequency-based characteristic extraction; and

FIG. 5 shows a schematic representation of an injection system for injecting fuel into the cylinder of an internal combustion engine using a control unit in which the sensor model is implemented.

### DETAILED DESCRIPTION

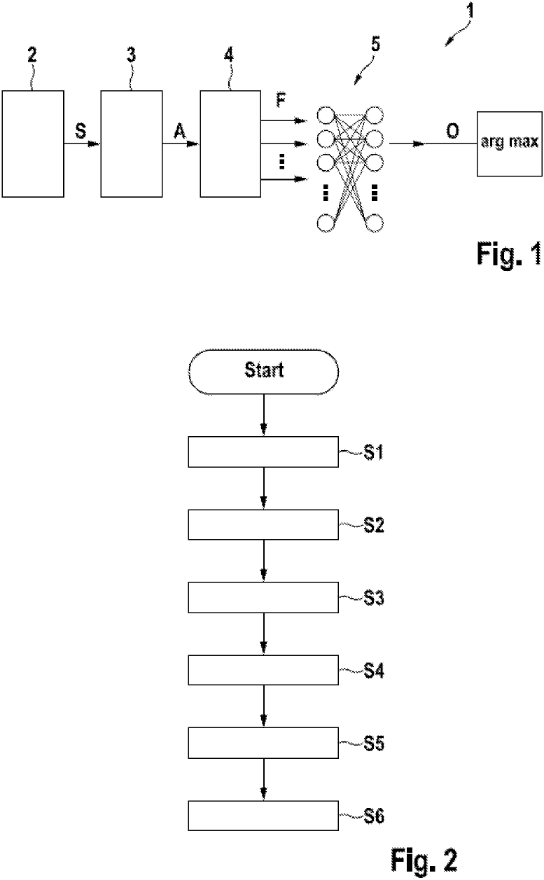

In the following, the evaluation of a sensor model is described in greater details in reference to a block diagram in FIG. 1 and a flow chart in FIG. 2.

FIG. 1 shows a sensor system 1 having a sensor 2 configured to record and detect continuous measurement signals. For example, the sensor 2 can correspond to a pressure sensor, a mass flow sensor, a temperature sensor, an accelerometer, a vibration sensor, a radiation sensor, or the like, and it is sampled at a sampling rate in step S1 in order to obtain a continuous sensor signal time series S with respect to discrete sampling steps.

The sensor signal time series S can correspond to the detection of a varying physical variable that changes according to, e.g., a cyclic process. The cyclic process is detected and includes a cyclic state change that translates into a physical variable change.

The sensor signal time series S is fed in step S2 to a preprocessing block 3, which cyclically applies an evaluation time window to the sensor signal time series S in order to determine an evaluation signal time series A. The evaluation signal time series features a predetermined number of samples, which are generated from the sensor signal time series S. The preprocessing block 3, depending on a specification for the evaluation time window, creates the evaluation signal time series A as a vector of predetermined length.

The evaluation signal time series A is timed with respect to the sensor signal time series such that the former includes the repeating state change of the change point time to the extent possible.

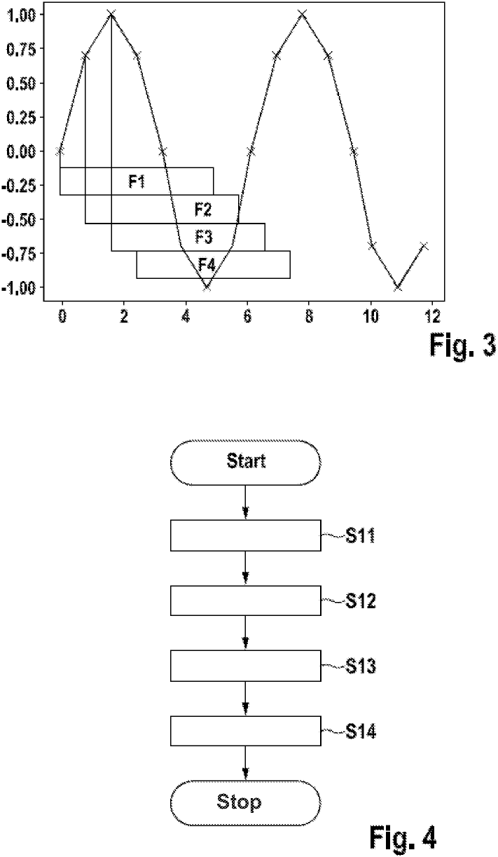

The evaluation signal time series A is fed to a characteristic extraction block 4 in step S3. From the evaluation signal time series extracts A, the characteristic extraction block 4 extracts respective signal time series extracts, which in each case correspond to an extract from the evaluation signal time series A and are shorter in length, e.g., measuring between 30% and 70% of the length of the evaluation signal time series A. The signal time series extracts are offset with respect to one another by, e.g., one or a predetermined number of sample values. FIG. 3 illustrates, by way of example, the potential relationship between the signal time series extracts F1, F2, F3, F4 and the evaluation signal time series A.

In characteristic extraction block 4, a frequency analysis function is further applied during step S4 to each of the signal time series extracts F1, F2, F3, F4, e.g., in the form of an FFT (Fast Fourier Transformation), a DFT (Discrete Fourier Transformation) or a Goertzel algorithm. The Goertzel algorithm represents a particular form of discrete Fourier transformation by which discrete spectral fractions can be efficiently calculated.

Using the frequency analysis, a spectral fraction, i.e., a frequency contribution from one or more predetermined frequencies, can be determined for each of the signal time series extracts F1, F2, F3, F4. These predetermined frequencies correspond to predetermined hyperparameters of the data-based sensor model.

The one or more frequency contributions F for each of the signal time series extracts F1, F2, F3, F4 are then fed to a sensor model 5 in the form of a single or multilayered neural network during step S5. The neuronal functions of the neural network are defined in an inherently known manner as the sum of the initial values for the preceding neuron layer (which are weighted using a weighting factor), or rather the frequency contributions, and a corresponding bias value. This sum can be applied to a non-linear activation function. The results can be output as an output vector for further processing in a future layer of neurons, or as a classification result.

In step S6, the sensor model 5 can therefore output an output vector O corresponding to a classification output. As described above, the output vector O comprises elements whose index value is at a point in time or time period within the evaluation window and is permanently associated therewith.

FIG. 4 is a flow chart illustrating training of the data-based sensor model 5. Starting from training datasets provided in step S11, which in each case comprise one evaluation signal time series A and, optionally, one or more further state variables of the technical system, as well as an associated label in the form of a classification vector, said series are initially fed to the characteristic extraction block 4, which is also used for analysis of the evaluation signal time series A described hereinabove.

As illustrated in FIG. 3, in step S12 the characteristic extraction block 4 divides the evaluation signal time series A into the signal time series extracts F1, F2, F3, F4, for which a frequency contribution, or rather frequency contributions, are determined in the manner described above. In step S13, one or more frequency contributions for predetermined frequencies and phases, which are fed as input variables in the form of an input vector to the sensor model 5 that is configured as a neural network, result from the frequency analysis corresponding to signal time series extracts F1, F2, F3, F4.

The neural network of the sensor model 5 is then trained during step S14 according to the resulting frequency contributions. In other words, even during training does the evaluation signal time series A provided using a training dataset that is divided into several signal time series extracts F1, F2, F3, F4, which are offset from one another, in each case represent a temporal extract from the evaluation signal time series A. For example, the evaluation signal time series A is associated with a label in the form of a change point time, particularly in the form of a classification vector, the argmax of which indicates a change point time. The classification vector used for training can have an entry 1 at an index position corresponding to the change point time of the label, whereas a value of 0 is provided at the remaining positions.

The neural network is trained using inherently known gradient-based methods, e.g. back propagation, in order to appropriately adjust the model parameters, i.e., the weightings and bias values of the artificial neurons. The neural network preferably comprises two layers of neurons, wherein the starting layer can be designed to perform only a dimensional reduction based on the dimension of the classification vector in the form of an output vector O.

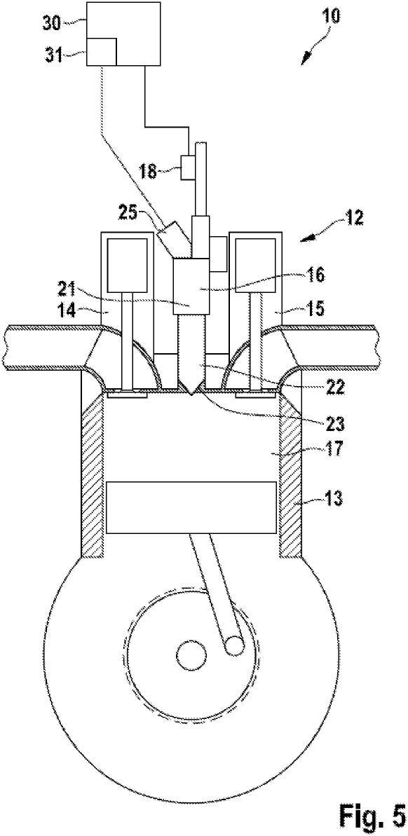

FIG. 5 shows, as an example of a sensor system 1, an injection system 10 for an internal combustion engine 12 of a motor vehicle, for which a cylinder 13 (of in particular several cylinders) is shown by way of example. The internal combustion engine 12 is preferably designed as a direct-injection diesel engine, but may also be provided as a gasoline engine.

The cylinder 13 comprises an intake valve 14 and an exhaust valve 15 for supplying fresh air and removing combustion exhaust.

Furthermore, fuel for operating the internal combustion engine 12 is injected into a combustion chamber 17 of the cylinder 13 via an injector valve 16. To this end, fuel is provided to the injector valve via a fuel supply 18, via which fuel is provided in an inherently known manner (e.g., a common rail) under high fuel pressure.

The injector valve 16 comprises an electromagnetically or piezoelectrically controllable actuator unit 21 coupled to a valve needle 22. In the closed state of the injector valve 6, the valve needle 22 is seated on a needle seat 23. By controlling the actuator unit 21, the valve needle 22 is moved longitudinally and exposes a portion of a valve opening in the needle seat 23 in order to inject the pressurized fuel into the combustion chamber 17 of the cylinder 13.

The injector valve 16 furthermore comprises a piezo sensor 25 arranged within the injector valve 6. The piezo sensor 25 is deformed by pressure changes in the fuel being conducted by the injector valve 6 and is generated by a voltage signal in the form of a sensor signal.

The injection is performed in a controlled manner by a control unit 30, which specifies a quantity of fuel to be injected by energizing the actuator unit 21. The sensor signal is sampled over time using an A/D converter 31 in the control unit 30, in particular at a sampling rate of 0.5 to 5 MHz. Doing so results in a sensor signal time series.

Furthermore, a pressure sensor 18 is provided in order to determine a fuel pressure upstream of the injector valve 16.

During operation of the internal combustion engine 12, the sensor signal is used to determine a correct opening or closing time of the injector valve 16. For this purpose, the sensor signal is, using the A/D converter 31 and via the indication from an evaluation time window, digitized into a corresponding sensor signal time series and evaluated by means of the above-described characteristic extraction and subsequent evaluation using the trained, data-based sensor model 5, whereby an opening duration for the injector valve 16 and, accordingly, an injected quantity of fuel can be determined, depending on the fuel pressure and further operating parameters. An opening time and a closing time are in particular needed in order to determine the opening duration, as the difference in time between these parameters.

In conjunction with the above sensor system 1, the sampled pressure signal corresponds to the sensor signal time series, wherein the controlling time for opening or closing the injector valve can be assumed as the change point time for the label. The evaluation time window arises as a result of the cyclic repetition of the injection process in an internal combustion engine with a temporal state that essentially begins substantially at a predetermined amount of time before the actuated opening time and can be determined as a crankshaft angle.

What is claimed is:

1. A method for evaluating a data-based sensor model for determining a change-point time in a sensor signal time series, the method comprising:
providing an evaluation signal time series within an evaluation time window of a sensor signal time series;
determining sensor signal extracts from the evaluation signal time series, the sensor signal extracts being (i) time-shifted with respect to one another, or (ii) respectively offset from one another by a number of sensing steps, the sensor signal extracts are shorter in length than the evaluation signal time series;
determining one or more frequency contributions from the sensor signal extracts using a fast Fourier transform (“FFT”) or a Goertzel algorithm; and
evaluating the one or more frequency contributions in a trained data-based sensor model in order to determine a change-point time within the evaluation time window.

2. The method according to claim 1, wherein the sensor model is trained to respectively associate a corresponding change-point time with the one or more frequency contributions from an evaluation-point time series.

3. The method according to claim 1, wherein the one or more frequency contributions are determined based on one or more predetermined frequencies or a phase state of an underlying sine or cosine signal.

4. The method according to claim 1, wherein the sensor model is configured as a single or multilayer neural network.

5. The method according to claim 1, wherein:
the sensor model is configured to indicate the change-point time as a classification vector, and
the change-point time is indicated as an argmax of the classification vector.

6. A device for carrying out the method according to claim 1.

7. A computer program product including instructions which, when executing the computer program product by a computer, cause the computer to execute the method according to claim 1.

8. A non-transitory machine-readable storage medium comprising instructions which, when executed by a computer, cause the computer to execute the method according to claim 1.

9. A method for training a data-based sensor model for evaluating an evaluation-point time series in order to determine a change-point time, comprising:
providing training datasets which are in each case indicative of an evaluation-point time series and a label including a change-point time;
determining sensor signal extracts from an evaluation-signal time series, which extracts are time-shifted with respect to one another or are respectively offset from one another by a number of sensing steps, the sensor signal extracts are shorter in length than the evaluation-signal time series;
determining one or more frequency contributions from the sensor signal extracts using a fast Fourier transform (“FFT”) or a Goertzel algorithm; and
training the data-based sensor model using the one or more frequency contributions and the change-point times associated therewith.

10. The method according to claim 9, wherein the data-based sensor model is configured as a deep neural network and is trained using a back propagation based training method.
